(19) United States
(12) Patent Application Publication
(10) Pub. No.: US 2009/0013398 A1
(43) Pub. Date: Jan. 8, 2009

(54) Remote Testing Of Firewalled Networks

(75) Inventors: Eugene N. Cookmeyer, II, Raleigh, NC (US); Sridevi Subramanian, Raleigh, NC (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: ACTERNA LLC, Germantown, MD (US)

(21) Appl. No.: 12/168,301

(22) Filed: Jul. 7, 2008

Related U.S. Application Data
(60) Provisional application No. 60/948,286, filed on Jul. 6, 2007.

(51) Int. Cl. G06F 21/00

(52) U.S. Cl. 726/11

(57) ABSTRACT

The present invention enables flexible deployment of testing agents within a firewalled network without the concern of needing to change security policies on routers and switches inside the firewalled network. Accordingly, remote diagnostic testing of networks and network devices can be conducted in which the firewalled network security is maintained and not compromised. The long-term diagnostic monitoring of networks is possible including an evolvable solution in which remote upgrades of the application agents are utilized.

### CROSS-REFERENCE TO RELATED APPLICATIONS

The present invention claims priority from U.S. Patent Application No. 60/948,286 filed Jul. 6, 2007, entitled “Method And System For Remote Testing In Firewalled Environments”, by Cookmeyer II, et al., which is incorporated herein by reference for all purposes.

### TECHNICAL FIELD

The present invention relates to the use of remote agents or probes to do testing within firewalled environments, and in particular wherein the agents are the initiators of communication to avoid needing to reconfigure the firewalls.

### BACKGROUND OF THE INVENTION

The concept of using remote agents or probes to do testing, e.g. sniffer distributed systems, within a user's network is disclosed in U.S. Pat. No. 7,246,159 issued Jul. 17, 2007 to Network General Corp. Communication initiated from within a firewalled network outbound to a remote server device has been disclosed in various systems that collect and push webpages and data. Automatic software updates for software programs with various applications, e.g. Windows XP, are well known.

An object of the present invention is to overcome the shortcomings of the prior art by providing a testing system for testing lines of communication extending from within a firewalled network to external the firewalled network using an application agent within the firewalled network, which initiates the testing, but which is controlled, monitored and updated from external the firewalled network, while maintaining the security of the network.

### SUMMARY OF THE INVENTION

Accordingly, the present invention relates to A method of testing a local communications network, which is coupled to a public network through a first firewall comprising:

a) providing a first agent for executing a plurality of tests corresponding to respective test requests, for installation on the local communications network inside the first firewall;

b) providing a first proxy server connected to a public network outside the first firewall for storing test requests and test results;

c) sending a test request from a remote source for said first agent to the first proxy server for storage therein;

d) sending a polling signal from the first agent to the first proxy server via the public network using an internet protocol in order to retrieve any test requests stored therein in a response to the polling signal;

e) executing the test corresponding to each test request on the local communication network via the first agent;

f) sending test results from the first agent to the first proxy server for storage therein; and

g) sending a request to the first proxy server from the remote source to retrieve any test results.

### BRIEF DESCRIPTION OF THE DRAWINGS

The invention will be described in greater detail with reference to the accompanying drawings which represent preferred embodiments thereof, wherein:

FIG. 1 is a schematic illustration of a network in accordance with an embodiment the present invention;

FIG. 2 is a schematic illustration of a network in accordance with an embodiment the present invention with multiple agents in the same network;

FIG. 3 is a schematic illustration of a network in accordance with an embodiment the present invention with multiple agents in different networks; and

FIG. 4 is a schematic illustration of a network in accordance with an embodiment the present invention illustrating an upgrading procedure.

### DETAILED DESCRIPTION

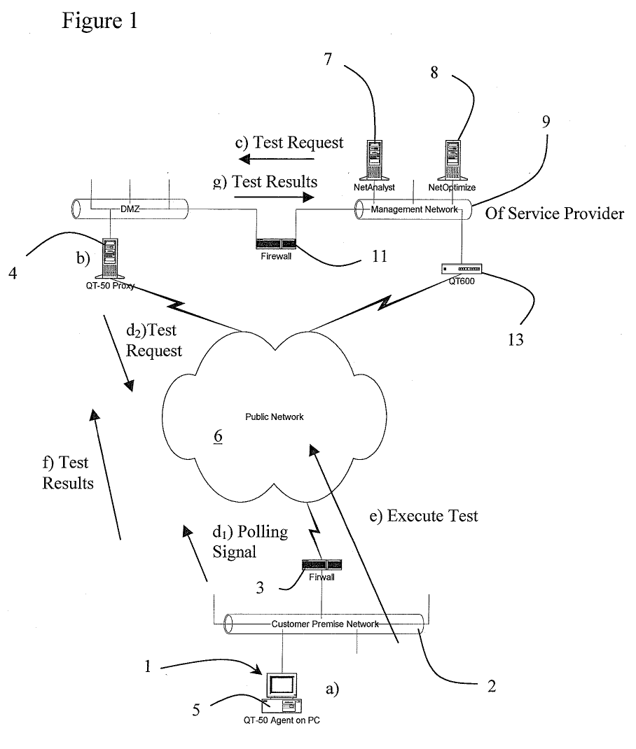

With reference to FIG. 1, an application agent 5, e.g. a QT-50® software agent, in accordance with the present invention, is installed on a computer device 1, e.g. a PC, in the customer's premise network 2, which is protected by a firewall 3. A proxy server 4, e.g. QT-Proxy server, resides in the public network 6 on the other side of the customer's firewall 3 to coordinate test functions on the application agent 5. The term agent in a preferred implementation of the present invention is a software agent, but can represent any device whose purpose is to do testing including hand-held testers, rack-mount hardware probes, and existing network equipment (servers, switches, routers, and hubs) that have software agent components installed upon them.

Test requests c) are initiated either via a first remote server 7, e.g. NetAnalyst® server, or via a second remote server 8, e.g. a NetOptimize® server, which coordinates the test through the first remote server 7. Preferably, the first remote server 7 and the second remote server 8 are found on a service provider's management network 9 protected by a firewall 11. Test requests are sent from the remote server, e.g. the NetAnalyst server 7 of the service provider's management network 9, to the proxy server 4, and held for an individual application agent 5 until a polling signal d₁ is received by the proxy server 4 from the application agent 5.

The application agent 5 sends the polling signal d₁ to the proxy server 4 via secure sockets layer (SSL: port 443) or hyper text transfer protocol (HTTP: port 80) on a manually selected, predetermined or random periodic basis, e.g. once a day or once a week, in order to receive any new “orders” for testing, i.e. if the proxy server 4 has stored any test requests c). Initiating communication from within the customer network 2 by the application agent 5 insures that security is maintained on the customer premise network 2, since the application agent 5 only initiates communications outbound from the customer premise network 2. No communications are initiated inbound to the customer premise network 2, maintaining firewall security at the customer premise boundary.

The test request is sent in the response to the outbound request of the agent 5 to the proxy server 4. All requests are initiated by the agent 5 and all QT Proxy commands to the agent 5 are sent in the response to the request. Accordingly, no separate communication is or needs to be initiated by the QT proxy server 4. The interval at which the agent 5 sends outbound requests is configurable.

When the application agent 5 receives a test request d₂ from the proxy server 4 in response to the polling signal d₁, the application agent 5 executes the test e), which was stored in the application agent 5, e.g. a voice call into or through the public network 6 to a remote testing module 13, e.g. a QT600 probe, connected to the public network 6, ideally found on the service provider's network 9. The QT600 is a hardware-based probe used mainly in the core of the network and at network aggregation points, for performing and/or facilitating all the tests that a QT-50 agent 5 does and more. The test request d₂ is sent in the response to the outbound polling signal d₁ of the application agent 5 to the proxy server 4. All requests are initiated by the agent 5 and all proxy commands to the agent 5 are sent in the response to the request d₁. The results f) of the test are then sent by the application agent 5 to the proxy server 4 for storage in memory therein. When desired, e.g. periodically or upon request, the test results g) are sent from the proxy server 4 to the first or second servers 7 and 8.

The software within the application agent 5, which includes details all of the tests, understands what each test is and how to perform them, but the parameters of each test may vary. Accordingly, individual test parameters can be sent in the test request d₂. Also the software in the application agent 5 can be upgraded and uninstalled remotely, i.e. from the proxy server 4, to install more tests as they become available, e.g. from the first and second remote servers 7 and 8. Tests performed by the application agent 5 include reach ability tests, voice quality measurement tests with monitoring, network analysis and packet capture, video monitor quality measurement tests with monitoring. The tests include remote network operation tests and network device diagnostic tests that are initiated both proactively and reactively.

Security of the service provider's management network 9 is maintained because all requests to the proxy server 4 are initiated within the management network 9.

By leveraging the technology of having the application agent 5 use HTTP to request instructions, via the public network 6 with the polling signal d₁, from the proxy server 4 and operate on the test request d₂ instructions enables various testing and agent-maintenance operations including:

a) coordination of tests between multiple application agents 5 within the same network 2 or within different networks. The QT-Proxy server 4 enables this coordination, when a QT-50 agent 5 communicates with another QT-50 agent 5, the signal goes through one or two QT-Proxy servers 4. When a QT-50 agent 5 communicates with a remote testing module 13, e.g. QT-600, it communicates through a single QT-Proxy server 4 and vice versa. The communication is used to coordinated the setup of the tests and then the actual “test traffic” is sent between the two test points using the technology involved (e.g. a VoIP test will communicate through a SIP Proxy or H.323 Gateway)

b) ability to remotely upgrade software agents;

c) ability to remotely uninstall software agents;

d) ability to change proxy address/location;

e) ability to support multiple proxy's in hierarchal tree to handle multiple firewalls and to be more scaleable; Multiple proxy servers 4 indicate that each QT-50 agent 5 will register with a single QT-Proxy server 4, but there may be many QT-Proxy servers 4 existing to handle as many QT-50 agents 5 as needed. Also multiple firewalls implies that there can be firewalls between the QT-50 agent 5 and the QT-Proxy server 4, and firewalls between the test management network 9 and the QT-Proxy server 4, as necessary. The only requirement is that port 80 or 443 (or another port configurable) be open outbound to the proxy server 4.

f) ability to add new test capabilities automatically. Using the software update process, the QT-50 agent 5 can be updated remotely to run the latest version of software supporting whatever tests we desire to add to the system; and

g) ability to uniquely identify agents without regard to location. Each QT-50 agent 5 is assigned a UUID that uniquely identifies the QT-50 agent 5 forever without regards to its IP address or subnet. In fact IP address and subnet can change as needed if the QT-50 agent 5 is moved across the network. This scenario is similar to a hand-held tester scenario where a technician carries the unit from location to location, but is always accessible once it is actively on the network.

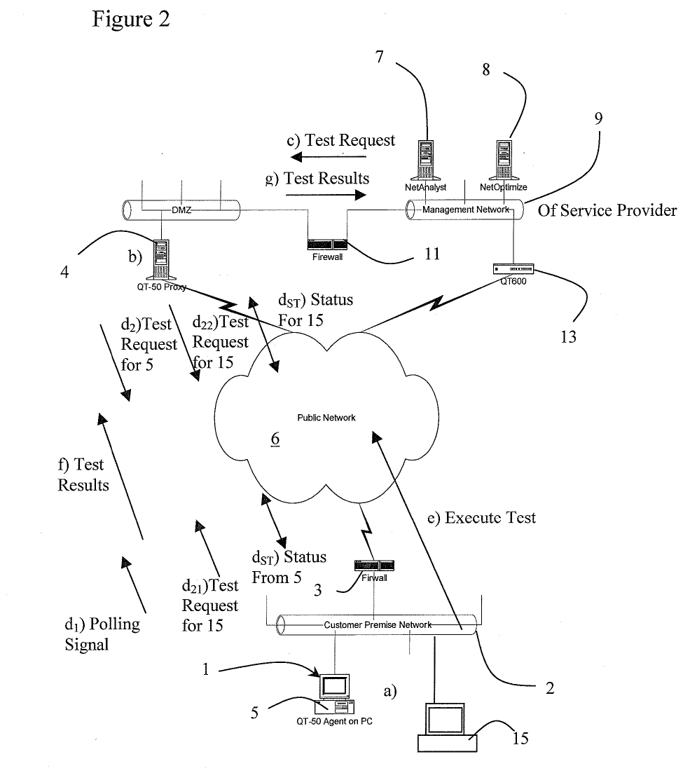

With reference to FIG. 2, the co-ordination of tests between multiple agents 5 and 15 within the same network 2 includes the case in which all of the agents 5 and 15 within the network 2 are registered to the same proxy server 4. In response to the polling signal d₁, the proxy server 4 sends the test request d₂ to one agent 5 mentioned in the test request d₂. If the test involves another agent 15, the test request d₂ contains information about the identifier of the second agent 15. The first agent 5 then constructs the test request d₂l for the second agent 15 and submits it to the proxy server 4. The proxy server 4 sends the test request d₂₂ to the second agent 15. The first agent 5 polls for test status d_{ST} of the second agent 15 via the proxy sever 4. The status message d_{ST} between the two agents 5 and 15 passed via the proxy server 4 is used to co-ordinate the start and completion of tests between the two agents 5 and 15. The results f) for both ends of the test will be collected by the first agent 5 and handed off to the proxy server 4.

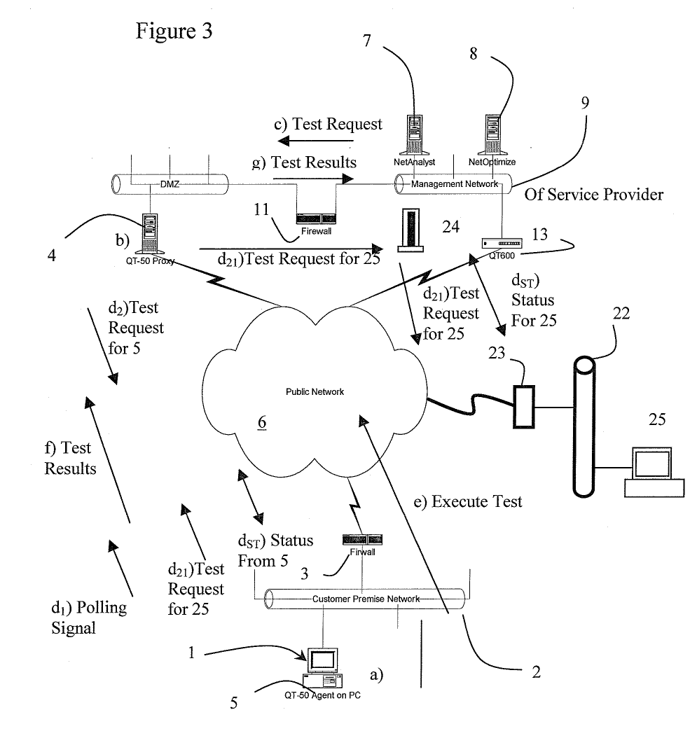

With reference to FIG. 3, in the case in which there is a second network 22 with its own firewall 23, and second agent 25 therein, it is possible that the two agents 5 and 25 are registered to two different proxy servers 4 and 24. In this case, in response to the polling signal d₁ from the first agent 5, the test request d₂ is sent to the first agent 5 via the first proxy server 4. In this case the test request d₁ has information about the second agent 25 and the second proxy server 24. The first agent 5 then constructs a test request d₂₁ for the second agent 25 which includes information about the second proxy server 24. The first proxy server 4 receives the test request d₂₁ and hands it off to the second proxy sever 24, which in turn passes the request d₂₁ to the second agent 25. From then on all test management communication between the two agents 5 and 25 proceeds via the two proxy servers 4 and 24. Again, the status message d_{ST} between the two agents 5 and 25 is used to co-ordinate the start and completion of tests e). The results f) for both ends of the test will be collected by the first agent 5 and handed off to the first proxy server 4.

For tests between agents, e.g. 5, 15 and 25 et al, involved in a mesh configuration, for example, periodic VoIP calls between agents for long term testing, each agent, e.g. 5, 15 and 25, is sent a mesh test configuration d₂ with information on which agent to call or which agent to receive a call from. In this scenario each agent 5, 15 and 25 receives a schedule and is ready to call or receive a call at the specified time mentioned in the test configuration d₂. The test configuration d₂ for each agent, e.g. 5, 15 and 25, is still sent by the proxy server 4 or proxy servers 4 and 24. Each agent, e.g. 5, 15 and 25, mentioned in the test request periodically reports the results for its end to the proxy server 4.

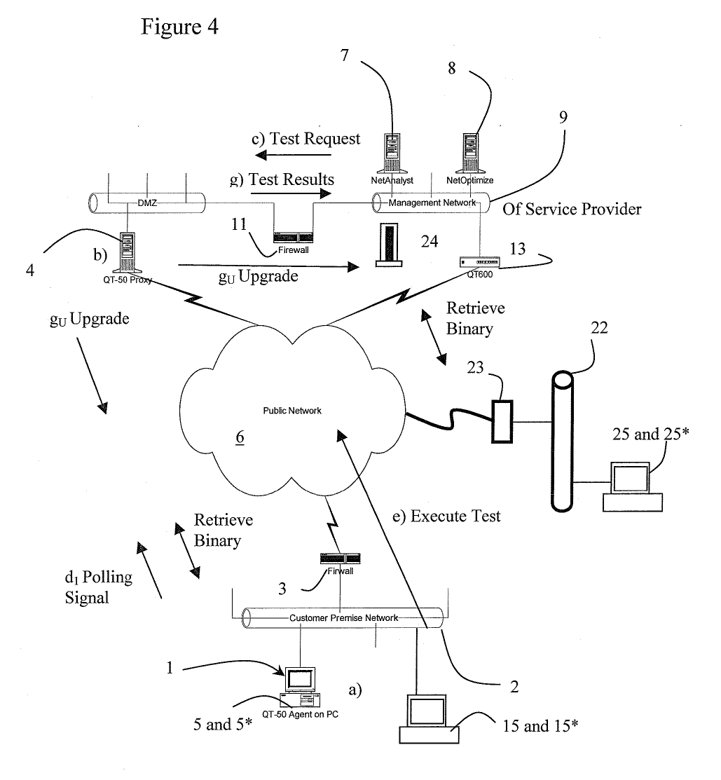

With reference to FIG. 4, to upgrade the software agents, e.g. 5, 15 or 25, in response to the polling signal d₁, the proxy server 4 sends an upgrade command g_{U} to the agent 5, 15 or 25 with a URL on the proxy server 4 from which to retrieve the binary for the upgrade. First, the agent 5, 15 or 25 terminates any tests that may be running, and then creates a separate local directory and goes into maintenance mode. The agent 5, 15 or 25 then retrieves the binary via a HTTP/HTTPS request using the URL provided by the proxy server 4. The agent 5, 15 or 25 also provides periodic status to the proxy server 4 on how the upgrade is proceeding. After the binary is downloaded by the agent 5, 15 or 25, the agent 5, 15 or 25 uses a MD5 checksum to validate the integrity of the downloaded file. The agent 5 then unzips the file into the new folder and launches another helper application and shuts itself down. The helper application confirms that the agent 5, 15 or 25 is shut down, moves the agent 5, 15 or 25 to a back up folder and proceeds to launch the installation contained in the list of files that were unzipped. Once the installation is successful, and the new agent 5*, 15* and 25* is launched, and the back-up folder is cleaned up. The new agent software 5*, 15* and 25* then restarts its communication with the proxy server 4 and communicates its upgraded version number and other details. If there is an error during installation the old agent software 5, 15 or 25 is moved out of the back up folder and is started back up. The old agent 5, 15 or 25 is also informed of the install error which is then communicated back to the proxy server 4. Using the aforementioned software update process, the agent 5, 15 or 25 can be updated remotely to run the latest version of software supporting whatever tests is desired to add to the system.

To uninstall the agent 5 (15 or 25), in response to the polling signal d₁, the proxy server 4 sends an uninstall command to the agent 5. The procedure is analogous to the upgrade process. The agent 5 confirms reception of the uninstall command, terminates any running tests, launches a helper application, and shuts itself down. The helper application is the same one used in the upgrade process, which is handed a different command line parameter. The helper application ensures that the agent 5 has shutdown, and then proceeds to invoke the uninstall process present in the agent 5 installation binaries.

To change the address or location of the proxy server 4, in response to the polling signal d₁, the proxy server 4 will issue a change proxy message to all its agents, e.g. 5 and 15 in FIG. 2, informing them of the new proxy server. The agents 5 and 15 will switch to the new proxy server and resume communications therewith. The old proxy server 4 can be removed off-line or moved to a new location after all agents 5 and 15 have switched to the new QT-Proxy.

Each agent, e.g. 5 and 15, generates a universally unique identifier (UUID) on startup. The UUID is communicated to the proxy server 4 along with an agent name if it exists. Each agent, e.g. 5 and 15, will be assigned a name by the proxy server 4, if they does not have one initially. The proxy server 4 uses the UUID to identify the agents, e.g. 5 and 15, without regard to their location. The UUIDs are sufficiently unique to guarantee that no two agents in the universe will have the same identifier. The agent name is a user friendly display entity which is mapped to its UUID. The proxy server 4 only ever uses the UUID to locate/communicate with an agent. Each agent 5 is assigned the UUID forever without regards to its IP address or subnet. In fact each IP address and subnet can change as needed if the agent 5 is moved across the network 2 or 6, and is therefore always accessible once it is actively on the network 2.

Multiple proxy servers indicate that each agent, e.g. 5 and 25, will register with a single proxy server, e.g. 4 and 24, respectively, but there can be many proxy servers existing to handle as many agents as needed. Also multiple firewalls that there can be firewalls 3 and 23 between the agents 5, 15 and 25 and the proxy servers 4 and 24, and firewalls 11 between the test management network 9 and the proxy servers 4 and 24, as necessary. The only requirement is that port 80 or 443 or another configurable port be open outbound to the proxy server 4. Page: 8

An example of an application agent 5 is the QT-50 software application agent 5 provided by the applicants of the present application, JDS Uniphase Corp (JDSU). Part of JDSU's NetComplete® Service Assurance VoIP portfolio, the QT-50 software application agent 5 ensures business-class quality of service (QoS) for service providers supporting the large-scale transition of their business customers to Voice-over-IP (VoIP) service. The QT-50 software application agent 5 equips service providers with the ability to proactively monitor and troubleshoot issues and evaluate metrics that can affect voice quality, such as mean opinion score (MOS), R-factor, jitter, packet loss, and packet statistics, by simulating the IP call experience as if at the customer premise network 2. With such proactive testing, problems can be identified and resolved before becoming noticeable to the end-users. Once a problem is discovered, the on-demand active testing features of the NetAnalyst server 7 enables the service provider to dig into and sectionalize the network, and rapidly isolate faults for troubleshooting. Service providers can also use the test results to proactively for trending and time-of-day analysis to identify areas of potential eminent degradation.

The QT-50 agent 5 supports multiple deployment options including self download to a PC, e.g. PC 1, and distribution via CD, email or FTP from the service provider. The QT-50 agent may also permanently reside on a dedicated 1 u high PC at the customer premises.

The QT-50 application agent 5 works with JDSU's operations support systems (OSS) or servers, called NetAnalyst and NetOptimize, to deliver both on-demand testing and performance management capabilities. The NetAnalyst and NetOptimize servers 7 and 8 place and receive active test calls between other software agents and JDSU QT probes, e.g. such as the QT-600 Ethernet and triple-play probes 13, deployed across a provider's network 9. By creating meshes of synthetic VoIP calls throughout the network 2, 6 or 22, the test system of the present invention proactively identifies potential degradations end-to-end, i.e. between hundreds of office buildings, for continuous and active monitoring of VoIP quality. The measurements and reports generated by the QT-50 agents 5 provide the key QoS metrics needed to instill confidence that call signal and voice clarity are of an exceptional level and meet customer expectations.

Ping and trace route tests are also run to verify connectivity throughout the network. By seamlessly internetworking with other QT-50 agents, e.g. 5, 15 and 25, and QT probes, e.g. 13, the service provider can initiate test calls to all points along the faulty path to limit the scope of the issue to a particular network segment. The NetOptimize server 8 further correlates the information with other network and service sources, further pinpointing the root cause of the problem.

We claim:

1. A method of testing a local communications network, which is coupled to a public network through a first firewall comprising:
a) providing a first agent for executing a plurality of tests corresponding to respective test requests, for installation on the local communications network inside the first firewall;
b) providing a first proxy server connected to a public network outside the first firewall for storing test requests and test results;
c) sending a test request from a remote source for said first agent to the first proxy server for storage therein;
d) sending a polling signal from the first agent to the first proxy server via the public network using an internet protocol in order to retrieve any test requests stored therein in a response to the polling signal;
e) executing the test corresponding to each test request on the local communication network via the first agent;
f) sending test results from the first agent to the first proxy server for storage therein; and
g) sending a request to the first proxy server from the remote source to retrieve any test results.

2. The method according to claim 1, wherein the remote source in step c) is a service provider's management network inside a second firewall.

3. The method according to claim 1, wherein in step c) the first agent sends the polling signal to the first proxy server via secure sockets layer or hyper text transfer protocol.

4. The method according to claim 1, wherein step e) includes placing a VOIP call from the first agent to a test probe remote from the local communication network via the public network.

5. The method according to claim 4, wherein the tests are selected from a group of remote network operation tests and network device diagnostic tests, which are initiated both proactively and reactively.

6. The method according to claim 5, wherein the tests are selected from the group consisting of reachability tests, voice quality measurement tests with monitoring, network analysis and packet capture, and video monitor quality measurement tests with monitoring.

7. The method according to claim 1, wherein software within the first agent includes details of each test, and other parameters of the test vary and are sent in the test request.

8. The method according to claim 1, wherein step d) includes upgrading of the first agent from the first proxy server to include additional tests.

9. The method according to claim 1, wherein the test requests include details of a second agent within the local communications network inside the first firewall; and wherein step d) further includes sending the test request from the first agent to the second agent via the first proxy server.

10. The method according to claim 1, wherein each of the first agents generates a universally unique identifier (UUID), and communicates the UUID to the first proxy server, whereby the first proxy server can identify the first agent wherever it is located.

11. The method according to claim 1, wherein the test requests include details of a second agent remote from the local communications network outside the first firewall on a remote communications network inside a remote firewall and connected to a second proxy server; and wherein step d) further includes sending the test request to the second agent via the first and second proxy servers.

12. The method according to claim 1, wherein step e) includes placing a plurality of VOIP calls are various times between various agents and various test probes.
